(19) United States
(12) Patent Application Publication
(10) Pub. No.: US 2013/0134197 A1
(43) Pub. Date: May 30, 2013

(54) Tear removal aid for improving the removal, more particularly manual removal, of a length of adhesive tape

(71) Applicants: Michael Siebert, Schenefeld (DE); Kevin Schröder, Macomb Township, MI (US)

(72) Inventors: Michael Siebert, Schenefeld (DE); Kevin Schröder, Macomb Township, MI (US)

(73) Assignee: tesa SE, Hamburg (DE)

(21) Appl. No.: 13/304,889

(22) Filed: Nov. 28, 2011

(51) Int. Cl. B26F 3/02

(52) U.S. Cl. 225/1; 225/91

(57) ABSTRACT

A tear removal aid and method improve the removal, more particularly manual removal, of a length of adhesive tape which has a textile carrier. The textile carrier has a two-dimensionally extended body having a flexural strength which corresponds at least to the flexural strength of a steel sheet having a thickness of 0.25 mm, preferably 0.50 mm, more preferably of 1.00 mm.

The invention relates to a tear removal aid for improving the removal, more particularly manual removal, of a length of adhesive tape, and also to the use thereof for removing, more particularly manually removing, a length of adhesive tape.

Many sectors of industry wrap bundles composed of a multiplicity of electrical leads, before installation or in the ready-installed state, in order by such bandaging to reduce the space taken up by the bundle of leads and also, in addition, to obtain protective functions. With film-based adhesive tapes, a certain level of protection from ingress of fluid is achieved; with airy and bulky adhesive tapes based on thick nonwovens or other textiles as carriers, insulating properties are obtained.

This wrapping is largely still performed predominantly by hand, owing to the complexity of the modern cable looms with their greater or lesser degrees of branching.

A parameter which is important particularly with regard to the processing properties, therefore, is the hand tearability of an adhesive tape.

A tearing strength in the transverse direction of less than 10 N, determined in accordance with the AFERA standard 4007, is used as the criterion for the hand tearability of an adhesive tape.

In order to improve the hand tearability, the possibility exists of optimizing the construction of the adhesive tapes.

Accordingly, EP 1 074 594 A2 describes a textile carrier bearing an applied, non-tacky layer of polymer whose primary purpose is to render the adhesive tape watertight. This watertight layer at the same time allows the carrier to be bound in such a way that it is easier to tear.

FR 2 797 268 A1 and also EP 1 074 595 B1, which originated from the French priority application, discloses a hand-tearable adhesive tape based on a woven polyester fabric, the fibres of the woven polyester fabric being fixed relative to one another by a layer of adhesive, so that on tearing by hand the force is concentrated on a small number of fibres.

EP 2 180 025 A1 discloses an adhesive tape having a textile carrier which allows the adhesive tape to be torn by hand, while not restricting the selection of the self-adhesive. For this purpose, again, the textile carrier bears an applied polymer layer, the polymer possessing a glass transition temperature of between −20° C. and +60° C. and having a static elasticity modulus and a polymer layer thickness selected such that the textile carrier according to DIN EN ISO 13937-2 has a tear propagation force in the transverse direction of not more than 10 N.

Furthermore, EP 1 990 393 A1 discloses a hand-tearable adhesive tape having a tapelike carrier, the carrier consisting of a woven fabric predominantly comprising threads which extend on the one hand as longitudinal threads in the longitudinal direction of the adhesive tape and on the other hand as transverse threads having a thread density of at least 18 threads per centimetre length (L) in the transverse direction of the adhesive tape, the width (W)-based linear density of the longitudinal threads being less than a length (L)-based linear density of the transverse threads. The width (W)-based linear density of the longitudinal threads is at least 2600 dtex/cm, the length (L)-based linear density of the transverse threads is at least 4700 dtex/cm. The thread density of the transverse threads is at least 28 threads per centimetre length (L), the longitudinal threads and the transverse threads being fixed relative to one another not only by the adhesive layer but additionally in such a way as to counter slipping.

For the additional relative fixing of the threads to one another there are a number of possibilities. For example, this fixing may be achieved by calendering. In addition or alternatively to the calendering, the threads may also be prefixed by a finish applied to the carrier—in the way in which ironing starch is used for garments—in the course of textile finishing, more particularly in a washing procedure with subsequent thermal treatment. Use may be made here of finishing compositions based on polyvinyl alcohol, acrylate and/or polyamide. Through the thermal treatment which follows the washing procedure, the finishing composition then brings about adhesive bonding or prefixing of the threads of the carrier. In addition, the threads can be fixed relative to one another to counter slipping by the use of textured yarns as longitudinal threads and/or transverse threads.

Woven fabrics are used very widely as carrier material for cable bandaging tapes. The woven fabrics are characterized by the thread material (polyester yarn, for example), the thread weight of the threads (weight per unit length, unit: dtex, 1 dtex=1 g/10 000 m of thread) and the thread density or thread count (number of threads per cm). Woven fabrics consist of warp threads (longitudinal direction, machine direction, also corresponding to the longitudinal direction of the adhesive tape produced from them) and weft threads (transverse threads).

The threads are typically woven in plain-weave construction. Other types of construction are satin weave and twill weave. Fabrics woven in twill weave (for example a “2 over 1 twill”) give rise to a so called twill line, which runs diagonally to the machine direction. Fabrics woven with twill weave are generally somewhat softer than the same woven fabrics in plain-weave construction. In the diagonal direction in particular, the flexural stiffness is lower. For adhesive tapes produced from these fabrics, this may be an advantage.

The threads may consist of spun yarns or filament yarns (continuous yarns). It is usual to use filament yarn. Such yarn consists of a set number of individual filaments, and may be textured or flat, with pointwise consolidation or no consolidation. The woven fabrics may be dyed subsequently or may consist of spundyed yarns.

Transverse linear density of a woven fabric is a term for the number of transverse threads (weft threads) per centimetre, multiplied by the thread weight of the transverse threads in dtex. The unit is dtex/cm.

Longitudinal linear density is a term for the number of longitudinal threads (warp threads) per centimetre, multiplied by the thread weight of the longitudinal threads in dtex. The unit is likewise dtex/cm.

The basis weight of the woven fabric is ultimately a product of the yarns used, their number and the nature of the weave.

Woven polyester fabrics utilized as carriers for cable wrapping tapes typically have basis weights of between 60 and 140 g/m².

The adhesive tapes improved in respect of their hand tearability are more complex and hence more expensive by comparison with the usual adhesive tapes.

Another important requirement imposed on the cable bandaging tapes is the mechanical protection of the cables they ensheathe. To meet this requirement, the adhesive tapes must have an extremely high abrasion resistance.

The rule here is that the thicker the adhesive tapes are the more abrasion resistant they are. In other words, with regard to the abrasion resistance, an attempt is made to use adhesive tapes which are extremely stable and therefore thick. The abrasion resistance of the adhesive tapes increases, furthermore, with the thickness of the fibres or threads used, and so in this respect as well an attempt is made to use threads or fibres which are extremely thick.

However, in turn, the desire for hand tearability imposes limits on the thickness of the tapes that are to be used, and more particularly on the thickness of the fibres and threads.

An ever-present compromise, therefore, is to select the thickness at not more than a level such that the adhesive tape continues to be hand-tearable.

Very strong adhesive tapes can then still be severed with the aid of a knife or shears. These tools are largely shunned in the wrapping operations, on account of the associated injury risk. Another argument against the use of such tools is the fact that, in addition to the risk of injury to the body of the user, it is also possible for the cables or their insulator casing themselves to be damaged, which can lead later to short circuits.

It is an object of the invention to obtain a marked improvement over the prior art by maximally improving the hand tearability of the adhesive tapes with textile carrier that are used, without having to alter or adapt the actual construction of the adhesive tapes with regard to the hand tearability.

This object is achieved by means of a tear removal aid as characterized more closely in the main claim. The dependent claims describe advantageous embodiments of the invention. Further encompassed by the concept of the invention is the use of the tear removal aid of the invention.

The invention accordingly provides a tear removal aid for improving the removal, more particularly manual removal, of a length of adhesive tape which has a textile carrier, consisting of a two-dimensionally extended body having a flexural strength which corresponds at least to the flexural strength of a steel sheet having a thickness of 0.25 mm, preferably 0.50 mm, more preferably of 1.00 mm.

The flexural strength is then at a level such that the body does not bend out of shape under the pressure exerted by a thumb or finger during the tearing operation.

The flexural strength is identified as “flexural stress on conventional bending (with 3.5% edge fibre elongation) with the unit [MPa] (3.5% flexural stress)”. The measurement method for the flexural strength is given in DIN EN ISO 178.

According to one preferred embodiment, the body is of substantially rectangular form. Alternatively the body may have the shape of an arc rectangle.

In the case of the rectangular variants, the angles are preferably rounded (for example in quadrant form).

According to one variant of the invention, the edges which run in the transverse direction are more rounded than the longitudinal edges, and so the tear removal aid has an ellipsoidal shape.

With further preference one edge of the body, preferably the arc, is provided with jags, preferably having a jag height of about 0.3 to 6 mm, more particularly 0.4 to 1.0 mm, especially 0.5 mm.

It has emerged as being advantageous, furthermore, if
the body has a width of not more than three centimetres, preferably a width of not more than two centimetres, more preferably a width of not more than one centimetre and/or
the body has a length of not more than ten centimetres, preferably a length of not more than five centimetres, more preferably a length of not more than three centimetres and/or
the body has a thickness of at least 0.025 centimetre, preferably a thickness of at least 0.5 centimetre, more preferably a thickness of at least 0.1 centimetre.

The tear removal aid consists preferably of steel or aluminium. According to one variant, the tear removal aid is fabricated from a plastic with appropriate flexural stiffness. Hardwood or horn are also suitable materials for the tear removal aid.

For increasing the flexural stiffness, the body may additionally be three-dimensionally structured and may preferably have a wave structure or a jag structure and/or may be provided with air inclusions.

With particular advantage the tear removal aid of the invention can be used for removing, more particularly manually removing, a length of adhesive tape which has a textile carrier.

The finding gained in accordance with the invention is that, for removing a length of adhesive tape, the tear removal aid is placed with pressure onto the carrier of the adhesive tape and, in the course of the tear removal operation, fixes the fibres or threads of the carrier in their position.

As a result of the fixing of the fibres or threads during the tear removal operation they are not pushed together to form a bundle which is no longer severable, as is normally the case, but can instead be severed one after another, thereby significantly reducing the force that needs to be applied for tear removal.

The tear removal aid of the invention has a key advantage. As a result of the fact that, as described, the fibres and threads are fixed in their position, it is also possible to perform a manual severing of adhesive tapes hitherto considered not to be hand-tearable.

In accordance with the invention it is now possible to remove lengths even of adhesive tapes which have a tearing strength in the transverse direction of up to 20 N according to AFERA standard 4007. Adhesive tapes of this kind were hitherto considered not to be hand-tearable.

A consequence of this is that, by virtue of the tear removal aid of the invention, it is possible to use adhesive tapes which have significantly thicker fibres or threads or which themselves are significantly thicker, for cable bandaging purposes. This increases the abrasion resistance of the adhesive tapes used, producing a considerable technical and economic advantage in the cable bandaging context.

Furthermore, it is not necessary to optimize the adhesive tapes used in terms of their hand tearability by having to take additional technical measures such as the application of an additional polymer layer or the use of textured fibres or threads.

The tear removal aid can be used advantageously in mechanized tear removal operations, through the use of an appropriately configured means to press the tear removal aid onto the adhesive tape carrier, while the adhesive tape is severed at this location.

Use in the context of manual tear removal operations is particularly advantageous.

For this purpose, the tear removal aid is fixed below a (human) finger of the wrapper (palmar side of the finger), so that one edge of the tear removal aid ends approximately at the level of the free end of the distal phalanx. If one edge on the tear removal aid is to have a jagged cut, it is of course this edge.

The finger may in principle be freely selected; preferably, the tear removal aid is placed below the index finger or thumb.

According to one preferred embodiment of the tear removal aid it is of arcuate form in the transverse direction, and as far as possible in an arc which is optimally tailored to the diameter of the finger, so that the tear removal aid conforms to the shape of the finger. The arc in this case may adopt values of up to 180°.

The manner of fixing on the finger may be selected arbitrarily.

The tear removal aid is preferably integrated in a fingerstall which can be pushed over the finger. Alternatively the tear removal aid may also be present in a glove which is pulled over the hand. With further preference the fingerstall and/or glove consist of a breathable material, in order to prevent perspiration accumulating.

In simple variants, the tear removal aid is fixed with one or two strips of adhesive tape, which are wound around the finger and at the same time around the tear removal aid.

In an alternative variant, the tear removal aid has a width covering two fingers positioned one beside the other.

A further great advantage of the tear removal aid is that it has no sharp edge of the knife blade kind (that is, no edge sharpened by corresponding grinding), thereby considerably reducing the risk of injury to the user and also the risk of damage to the cables.

Furthermore, the use of the tear removal aid does not cause any delay in the wrapping operation. As has been the case hitherto as well, the adhesive tape is severed manually, without any need to pick up shears or a knife or any other tool.

For the tear removal operation, the adhesive tape is taken between tear removal aid (preferably on the thumb) and index finger. In this operation, the pressure fixes the individual fibres or threads in the textile carrier in their position. Fixing does not absolutely necessitate pressure being applied against the index finger. This means, when the other hand initiates the tear removal operation, severing is performed thread by thread in succession. The force applied acts specifically on each individual fibre.

The problem to date was that, when an attempt was made to carry out manual severing of an adhesive tape with textile carrier, the fibres or threads were not sufficiently fixed in the structure, and so they were pushed together until a more or less dense bunch of threads was present, with a force that would be necessary to tear such a bunch being no longer possible to apply.

The tear removal aid of the invention prevents this “bunching”, hence now allowing manual severing even of those adhesive tapes hitherto considered not to be hand-tearable.

As textile carrier for the adhesive tape to be severed it is possible to use all known textile carriers such as knitted fabrics, scrims, tapes, braids, tufted textiles, felts, woven fabrics (encompassing plain weave, twill and satin weave), knits (encompassing warp knits and other knits) or nonwoven webs, the term “nonwoven web” comprehending at least sheetlike textile structures in accordance with EN 29092 (1988) and also stitch bonded webs and similar systems.

It is likewise possible to use woven and knitted spacer fabrics with lamination.

The tear removal aid is used more preferably with the following woven fabrics:
Yarn density of the warp threads: 55 dtex to 130 dtex, preferably 55 dtex to 110 dtex, more preferably 83 dtex to 110 dtex. (To date only woven fabrics with 83 dtex warp threads that are hand-tearable are known.)
Thread count for the warp threads: 20 to 60, preferably 30 to 50.
Maximum linear density limit of the warp threads not more than 7000 dtex/cm, preferably 6500 dtex/cm, more preferably 6000 dtex/cm. Through the use of the tear removal aid of the invention it is possible to extend significantly the existing known range for a tearable adhesive tape.
Plain weave (standard for every known hand-tearable tape), twill weave, satin weave.

Suitable nonwovens include, in particular, consolidated staple fibre webs, but also filament webs, meltblown webs, and spunbonded webs, which generally require additional consolidation. Known consolidation methods for webs are mechanical, thermal, and chemical consolidation. Whereas with mechanical consolidations the fibres are mostly held together purely mechanically by entanglement of the individual fibres, by the interlooping of fibre bundles or by the stitching-in of additional threads, it is possible by thermal and by chemical techniques to obtain adhesive (with binder) or cohesive (binderless) fibre-fibre bonds. Given appropriate formulation and an appropriate process regime, these bonds may be restricted exclusively, or at least predominantly, to the fibre nodal points, so that a stable, three-dimensional network is formed while retaining the loose open structure in the web.

Webs which have proven particularly advantageous are those consolidated in particular by overstitching with separate threads or by interlooping.

Consolidated webs of this kind are produced, for example, on stitchbonding machines of the “Malimo” type from the company Karl Mayer, formerly Malimo, and can be obtained, inter alia, from the company Techtex GmbH. A Malifleece is characterized in that a cross-laid web is consolidated by the formation of loops from fibres of the web.

The carrier used may also be a web of the Kunit or Multiknit type. A Kunit web is characterized in that it originates from the processing of a longitudinally oriented fibre web to form a sheetlike structure which has loops on one side and, on the other, loop feet or pile fibre folds, but possesses neither threads nor prefabricated sheetlike structures. A web of this kind has been produced, inter alia, for a long time, for example on stitchbonding machines of the “Malimo” type from the company Karl Mayer. A further characterizing feature of this web is that, as a longitudinal-fibre web, it is able to absorb high tensile forces in the longitudinal direction. The characteristic feature of a Multiknit web relative to the Kunit web is that the web is consolidated on both the top and bottom sides by virtue of the double-sided needle punching. The starting product for a Multiknit is generally one or two single-sidedly interlooped pile fibre nonwovens produced by the Kunit process. In the end product, both top sides of the nonwovens are shaped by means of interlooped fibres to form a closed surface, and are joined to one another by fibres which stand almost perpendicularly. An additional possibility is to introduce further needlable sheetlike structures and/or scatterable media.

Finally, stitchbonded webs are also suitable as an intermediate forming a sheath and an adhesive tape. A stitchbonded web is formed from a nonwoven material having a large number of stitches extending parallel to one another. These stitches are brought about by the incorporation, by stitching or knitting, of continuous textile threads. For this type of web, stitchbonding machines of the “Malimo” type from the company Karl Mayer, formerly Malimo, are known.

Also particularly suitable are needlefelt webs. In a needlefelt web, a tuft of fibres is made into a sheetlike structure by means of needles that carry barbs. By alternate introduction and withdrawal of the needles, the material is consolidated on a needle bar, with the individual fibres interlooping to form a firm sheetlike structure. The number and configuration of the needling points (needle shape, penetration depth, double-sided needling) determine the thickness and strength of the fibre structures, which are in general lightweight, air-permeable and elastic.

Also particularly advantageous is a staple fibre web which is mechanically preconsolidated in the first step or is a wet-laid web laid hydrodynamically, in which between 2% and 50% by weight of the web fibres are fusible fibres, in particular between 5% and 40% by weight of the fibres of the web.

A web of this kind is characterized in that the fibres are laid wet or, for example, a staple fibre web is preconsolidated by the formation of loops from fibres of the web by needling, stitching or air-jet and/or water-jet treatment.

In a second step, thermofixing takes place, with the strength of the web being increased again by the (partial) melting of the fusible fibres.

For the utilization of nonwovens, the adhesive consolidation of mechanically preconsolidated or wet-laid webs is of particular interest, it being possible for said consolidation to take place by way of the addition of binder in solid, liquid, foamed or pastelike form. A great diversity of theoretical embodiments is possible: for example, solid binders as powders for trickling in; as a sheet or as a mesh, or in the form of binding fibres. Liquid binders may be applied as solutions in water or organic solvents or as a dispersion. For adhesive consolidation, binder dispersions are predominantly chosen: thermosets in the form of phenolic or melamine resin dispersions, elastomers as dispersions of natural or synthetic rubbers, or, usually, dispersions of thermoplastics such as acrylates, vinyl acetates, polyurethanes, styrene-butadiene systems, PVC, and the like, and also copolymers thereof. Normally, the dispersions are anionically or nonionically stabilized, although in certain cases cationic dispersions may also be of advantage.

The binder may be applied in a manner which is in accordance with the prior art and for which it is possible to consult, for example, standard works of coating or of nonwoven technology such as “Vliesstoffe” (Georg Thieme Verlag, Stuttgart, 1982) or “Textiltechnik-Vliesstofferzeug ung” (Arbeitgeberkreis Gesamttextil, Eschborn, 1996).

For mechanically preconsolidated webs which already possess sufficient composite strength, the single-sided spray application of a binder is appropriate for effecting specific changes in the surface properties.

Such a procedure is not only sparing in its use of binder but also greatly reduces the energy requirement for drying. Since no squeeze rolls are required and the dispersions remain predominantly in the upper region of the web material, unwanted hardening and stiffening of the web can be avoided on the whole.

For sufficient adhesive consolidation of the web backing, the addition of binder in the order of magnitude of from 1% to 50%, in particular from 3% to 20%, based on the weight of the fibre web, is generally required.

The binder may be added as early as during the manufacture of the web, in the course of mechanical preconsolidation, or else in a separate process step, which may be carried out in-line or off-line. Following the addition of the binder it is necessary temporarily to generate a condition for the binder in which the binder becomes adhesive and adhesively connects the fibres—this may be achieved during the drying, for example, of dispersions, or else by heating, with further possibilities for variation existing by way of area or partial application of pressure. The binder may be activated in known drying tunnels, or else, given an appropriate selection of binder, by means of infrared radiation, UV radiation, ultrasound, high-frequency radiation or the like. For the subsequent end use it is sensible, although not absolutely necessary, for the binder to have lost its tack following the end of the web production process. It is advantageous that, as a result of the thermal treatment, volatile components such as fibre assistants are removed, giving a web having favourable fogging values, so that when a low-fogging adhesive is used it is possible to produce an adhesive tape having particularly advantageous fogging values; accordingly, even the enclosing cover has a very low fogging value as well.

A further, special form of adhesive consolidation consists in activating the binder by incipient dissolution or swelling. In this case it is also possible in principle for the fibres themselves, or admixed special fibres, to take over the function of the binder. Since, however, such solvents are objectionable on environmental grounds, and/or are problematic in their handling, for the majority of polymeric fibres, this process is not often employed.

Advantageously and at least in regions, the carrier has a single-sidedly or double-sidedly polished surface, preferably in each case a surface polished over the whole area. The polished surface may be chintzed, as elucidated in detail in EP 1 448 744 A1, for example.

Starting materials for the textile carrier include more particularly (manmade) fibres, (staple fibre or continuous filament) made from synthetic polymers, also called synthetic fibres, made from polyester such as polyethylene terephthalate (PET), polyamide, polyimide, aramid, polyolefin, polyacrylonitrile, polylactic acid (PLA) or glass, (manmade) fibres made from natural polymers such as cellulosic fibres (viscose, Modal, Lyocell, Cupro, acetate, triacetate, Cellulon), such as rubber fibres, such as plant protein fibres and/or such as animal protein fibres and/or natural fibres made of cotton, sisal, flacks, silk, hemp, linen, coconut or wool. The present invention, however, it not confined to the materials stated; it is instead possible, as evident to the skilled person without having to take an inventive step, to use a multiplicity of further fibres in order to produce the textile carrier.

Likewise suitable, furthermore, are yarns fabricated from the fibres specified.

Staple fibres are individual fibres which are limited in their length. The opposite of staple fibres are filaments (continuous fibres). All natural fibres are staple fibres, since they occur only up to a defined length. All manmade fibres can be chopped to form staple fibres. In the text below, the staple fibres are also referred to, for simplification, simply as fibres.

In the case of woven fabrics or scrims, individual threads may be produced from a blend yarn, and thus may have synthetic and natural constituents. Generally speaking, however, the warp threads and the weft threads are each formed of a single kind.

The warp threads and/or the weft threads may in each case be composed only of synthetic threads or of threads made from natural raw materials.

The textile carrier preferably consists of a woven fabric.

One particularly preferred embodiment encompasses a textile carrier based on nonwoven or on woven fabric which additionally consists of polyester fibres, polyester filaments or polyester threads.

The fibre thickness is preferably 1 to 5 dtex (1 dtex: 1 gram per 1000 metres), preferably 1.7 to 3.6 dtex.

The fibre length is preferably 50 to 100 mm, more preferably 60 to 85 mm.

In accordance with a further preferred embodiment of the invention, the basis weight for the textile carrier is between 30 g/m² and 180 g/m².

In order to produce an adhesive tape from the carrier it is possible to employ any known adhesive systems. Besides natural or synthetic rubber based adhesives it is possible to make use, in particular, of silicone adhesives, and also of polyacrylate adhesives, preferably a low molecular mass acrylate hotmelt pressure-sensitive adhesive. On account of their particular suitability as the adhesive for wrapping tapes for automotive cable looms, in view of the absence of fogging, and the outstanding compatibility with both PVC and PVC-free core insulations, solvent-free acrylate hotmelt compositions are preferable, as described in more detail in DE 198 07 752 A1 and also in DE 100 11 788 A1.

The adhesive is preferably a pressure-sensitive adhesive, in other words a viscoelastic composition which at room temperature in the dry state remains permanently tacky and adhesive. Bonding takes place through gentle applied pressure immediately to virtually all substrates.

One adhesive which is found to be particularly suitable is a low molecular mass, pressure-sensitive, acrylate hotmelt adhesive of the kind carried by BASF under the acResin UV name. This adhesive, with a low K value, acquires its application-compatible properties as a result of a concluding, radiation-induced crosslinking operation.

The adhesive coating is likewise preferably composed of an adhesive based on synthetic rubber, more particularly an adhesive comprising at least one vinylaromatic block copolymer and at least one tackifier resin. Typical use concentrations for the block copolymer lie at a concentration in the range between 30% and 70% by weight, more particularly in the range between 35% and 55% by weight.

As further polymers it is possible for those based on pure hydrocarbons, such as unsaturated polydienes, for example, such as natural or synthetically produced polyisoprene or polybutadiene, chemically substantially saturated elastomers, such as saturated ethylene-propylene copolymers, α-olefin copolymers, polyisobutylene, butyl rubber, ethylene-propylene rubber, for example, and also chemically functionalized hydrocarbons such as, for example, halogen-containing, acrylate-containing or vinyl ether-containing polyolefins to be present, and these polymers may replace up to half of the vinylaromatic-containing block copolymers.

The tackifiers used are tackifier resins which are compatible with the elastomer block of the styrene block copolymers.

As further additives it is possible typically to use light stabilizers, such as, for example, UV absorbers, sterically hindered amines, antiozonants, metal deactivators, processing auxiliaries, and endblock-reinforcing resins.

Plasticizing agents such as, for example, liquid resins, plasticizer oils or liquid polymers of low molecular mass, such as low molecular mass polyisobutylenes having molar masses <1500 g/mol (number average), or liquid EPDM types, are typically employed.

Fillers such as, for example, silicon dioxide, glass (ground or in the form of beads), aluminium oxides, zinc oxides, calcium carbonates, titanium dioxides, carbon blacks, to name but a few, and also colour pigments and dyes, and also optical brighteners, may likewise be used.

Pressure-sensitive adhesives are typically admixed with primary and secondary antioxidants in order to improve their ageing stability. Primary antioxidants react with oxy and peroxy radicals, which may form in the presence of oxygen, and react with them to form less reactive compounds. Secondary antioxidants effect reduction, for example, of hydroperoxides to alcohols. There is known to be a synergistic effect between primary and secondary ageing inhibitors, and so the protective effect of a mixture is frequently greater than the sum of the two individual effects.

If the adhesive tape described is to be of low flammability, this quality can be achieved by adding flame retardants to the carrier and/or to the adhesive. These retardants may be organobromine compounds, where appropriate with synergists such as antimony trioxide, although, with regard to the absence of halogen from the adhesive tape, preference will be given to using red phosphorus, organophosphorus compounds, mineral compounds or intumescent compounds, such as ammonium polyphosphate, alone or in conjunction with synergists.

The pressure-sensitive adhesives may be prepared and processed from solution, from dispersion and also from the melt. Preferred preparation and processing methods are from the melt. For the latter case, suitable preparation processes include both batch methods and continuous methods.

The adhesive may be applied partially, for example in the longitudinal direction of the adhesive tape, in the form of a stripe, the width of the stripe being lower than that of the carrier of the adhesive tape.

Depending on the particular utility, it is also possible for the carrier material to be coated with two or more parallel stripes of the adhesive.

The position of the stripe on the carrier is freely selectable, preference being given to an arrangement directly at one of the edges of the carrier.

On the adhesive coating of the carrier there may be at least one stripe of a covering, extending in the longitudinal direction of the adhesive tape and covering between 20% and 80% of the adhesive coating.

In accordance with one preferred embodiment of the invention there is precisely one stripe of the covering present on the adhesive coating.

The position of the stripe on the adhesive coating is freely selectable, with preference being given to an arrangement directly at one of the longitudinal edges of the carrier. In this way an adhesive stripe is produced which extends in the longitudinal direction of the adhesive tape and finishes at the other longitudinal edge of the carrier.

Where the adhesive tape is used to wrap a cable loom, by the adhesive tape being led in a helicoidal movement around the cable loom, the sheathing of the cable loom may be accomplished by bonding the adhesive of the adhesive tape only to the adhesive tape itself, with the material not coming into contact with any adhesive.

The cable loom wrapped in this way has a very high flexibility as a result of the absence of fixing of the cable by any adhesive. Consequently its flexibility on installation—particularly in narrow passages or sharp bends—is significantly increased.

If a certain degree of fixing of the adhesive tape on the material is desired, then wrapping may be accomplished by bonding part of the adhesive stripe to the adhesive tape itself, and another part to the material.

In accordance with another advantageous embodiment, the stripe is applied centrally on the adhesive coating, thereby producing two adhesive stripes extending on the longitudinal edges of the carrier in the longitudinal direction of the adhesive tape.

For the secure and economic application of the adhesive tape in said helicoidal movement around the cable loom, and to counter the slipping of the resultant protective sheathing, the two adhesive stripes each present on the longitudinal edges of the adhesive tape are advantageous, especially if one, which is usually narrower than the second stripe, serves as a fixing aid and the second, broader stripe serves as a fastener. In this way, the adhesive tape is bonded to the cable in such a way that the cable loom is secured against slipping but is nevertheless of flexible design.

In addition there are embodiments in which more than one stripe of the covering is applied to the adhesive coating. Where reference is made only to one stripe, the skilled person reads this, conceptually, as accommodating the possibility that there may well be two or more stripes covering the adhesive coating at the same time.

The stripe preferably covers a total of between 50% and 80% of the adhesive coating. The degree of coverage is selected as a function of the application and of the diameter of the cable loom.

With particular preference there remain one or two adhesive stripes, whose total width accounts for 20% to 50% of the width of the carrier.

Particularly if the adhesive coating is not a full-area coating but instead, for example, is in stripe form, the stated percentages relate to the width of the stripes of the jacket in relation to the width of the carrier, or, in accordance with the invention, the stripe or stripes of the jacket have a width which accounts for between 20% and 80% of the width of the carrier.

The adhesives thus prepared can then be applied to the carrier using the methods that are general knowledge. In the case of processing from the melt, these may be application methods via a nozzle or a calender.

In the case of methods from solution, coatings with rods, blades or nozzles are known, to name but a few.

Also possible is a transfer of the adhesive from a non-stick backing cloth or release liner onto the carrier assembly.

The reverse face of the adhesive tape may be coated with a reverse-face lacquer in order to exert a favourable influence on the unwind properties of the adhesive tape wound to an Archimedean spiral. For this purpose this reverse-face lacquer may be furnished with silicone compounds or fluorosilicone compounds and also with polyvinylstearylcarbamate, polyethyleneiminestearylcarbamide or organofluorine compounds as abhesive substances.

The reverse-face lacquer should be used very sparingly, if at all, in order not to provoke flagging of the subsequently bonded adhesive tape.

The general expression “adhesive tape” in the context of this invention encompasses all sheetlike structures such as two-dimensionally extended films or film sections, tapes with extended length and limited width, tape sections and the like, and also, lastly, die cuts or labels.

The adhesive tape may be produced in the form of a roll, in other words wound up onto itself in the form of an Archimedean spiral, or lined on the adhesive side with release materials such as siliconized paper or siliconized film.

Suitable release material is preferably a non-linting material such as a polymeric film or a well-sized long-fibre paper.

The adhesive tape is preferably used for wrapping elongate material such as, more particularly, cable looms, with the elongate material being ensheathed in the axial direction by the adhesive tape, or with the adhesive tape being led in a helical motion around the elongate material. The resulting form is that of a helix (also called screw, screw line, cylindrical spiral or coil; a helix is a line which winds with constant pitch around the surface of a cylinder).

The adhesive tape can also be used in a sheath which consists of a jacket in which the self-adhesive tape is present at least in an edge region of the jacket, and is bonded to the jacket in such a way that the adhesive tape extends over one of the longitudinal edges of the jacket, and preferably in an edge region which is narrow in comparison to the width of the jacket.

One product of this kind, and also optimized embodiments thereof, are disclosed in EP 1 312 097 A1. EP 1 300 452 A2, DE 102 29 527 A1 and WO 2006 108 871 A1 depict onward developments. The adhesive tape can also be used in a process of the kind disclosed by EP 1 367 608 A2.

Lastly, EP 1 315 781 A1 and DE 103 29 994 A1 describe further embodiments of adhesive tapes.

In the text below, the intention, using a number of figures, is to provide further details of the adhesive tape, without wishing thereby to impose a restriction of any kind whatsoever.

### BRIEF DESCRIPTION OF THE DRAWINGS

FIG. 1 and FIG. 2 show a number of embodiments of the tear removal aid of the invention;

FIG. 3 shows the tear removal aid fixed with adhesive tape on a fingerstall.

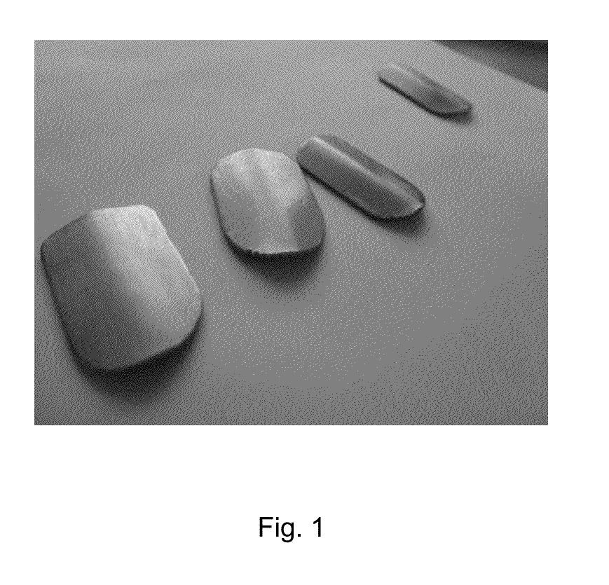

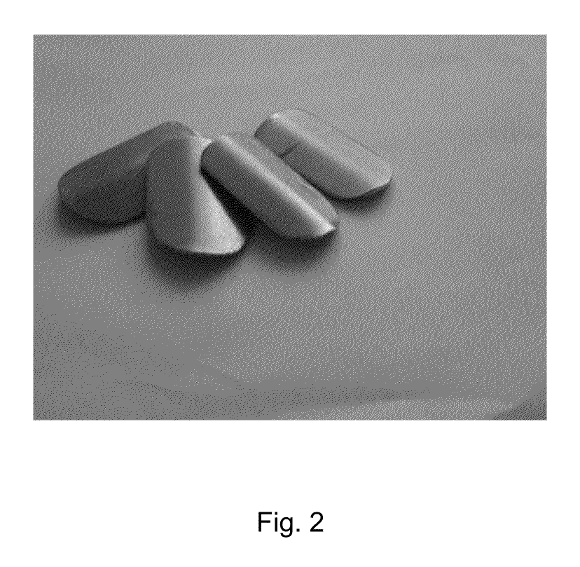

FIGS. 1 and 2 show tear removal aids of the invention which are used for improving the manual removal of a length of adhesive tape which has a textile carrier.

They consist of a two-dimensionally extended body having a flexural strength which corresponds at least to the flexural strength of a steel sheet having a thickness of 0.25 mm.

In this case the tear removal aids consist of steel sheet.

The bodies have a width of between 1.5 and 2.5 centimetres.

The length is four centimetres.

The thickness is 0.5 centimetre.

All tear removal aids are of arcuate form in the transverse direction, more specifically in an arc which is tailored optimally to the diameter of the finger, so that the tear removal aid conforms to the shape of the finger.

The leading edge of the body is arched and provided with jags, which have a height of 0.5 mm.

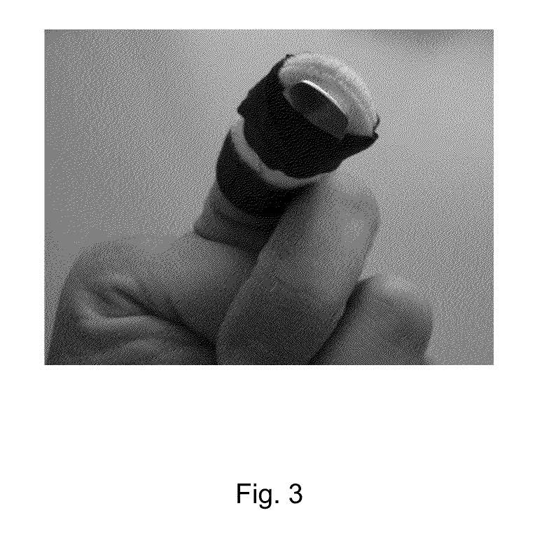

FIG. 3 shows how the tear removal aid is fixed with adhesive tape on a fingerstall.

We claim:

1. A tear removal aid for improving the removal of a length of adhesive tape having a textile carrier, the tear removal aid consisting of a two-dimensionally extended body having a flexural strength correspondings at least to a flexural strength of a steel sheet having a thickness of 0.25 mm.

2. The tear removal aid according to claim 1, wherein the body is substantially rectangular in form or has a shape of an arc rectangle.

3. The tear removal aid according to claim 1, wherein one edge of the body is provided with jags having a jag height of about 0.3 to 6 mm.

4. The tear removal aid according to claim 1, wherein the body has a width of not more than 3 cm, a length of not more than 10 cm and/or a thickness of at least 0.025 cm.

5. The tear removal aid according to claim 1, wherein the tear removal aid is of arcuate form in a transverse direction.

6. The tear removal aid according to claim 1, wherein the tear removal aid has no edge sharpened by grinding.

7. The tear removal aid according to claim 1, wherein the tear removal aid is integrated in a fingerstall or in a glove.

8. A tear removal aid according to claim 1, wherein, for increasing the flexural stiffness of the tear removal aid, the body is additionally three-dimensionally structured, has a wave structure or a jag structure or is provided with air inclusions.

9. A method for aiding removal of an adhesive tape having a textile carrier, the method comprising:
fixing the tear removal aid according to claim 1 under a finger or a thumb with the adhesive tape; and
removing a length of the adhesive tape with the tear removal aid.

10. A method for aiding removal of an adhesive tape having a textile carrier, the method comprising:
fixing the tear removal aid according to claim 1 under a finger with the adhesive tape, such that one edge of the tear removal aid ends approximately at a level of a free end of a distal phalanx; and
removing a length of adhesive tape with the tear removal aid.

11. The method according to claim 10, wherein the tear removal aid is fixed to a palmar side of the finger.

12. A method for aiding removal of an adhesive tape having a textile carrier, the method comprising:
fixing the tear removal aid according to claim 1 under a thumb with the adhesive tape, such that one edge of the tear removal aid ends approximately at a level of a free end of a distal phalanx; and removing a length of adhesive tape with the tear removal aid.

13. The method according to claim 12, wherein the tear removal aid is fixed to a palmar side of the thumb.

14. The tear removal aid according to claim 1, wherein the flexural strength of the body correspondings at least to the flexural strength of a steel sheet having a thickness of 0.50 mm

15. The tear removal aid according to claim 1, wherein the flexural strength of the body correspondings at least to the flexural strength of a steel sheet having a thickness of 1.00 mm.

16. The tear removal aid according to claim 3, wherein the jag height of the jags is about 0.4 to 1 mm.

17. The tear removal aid according to claim 16, wherein the jag height of the jags is about 0.5 mm.
